(19) United States
(12) Patent Application Publication
(10) Pub. No.: US 2006/0129376 A1
(43) Pub. Date: Jun. 15, 2006

(54) Identifying a document's meaning by using how words influence and are influenced by one another

(75) Inventor: Jason Wiener, Chicago, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: Dipsie, Inc.

(21) Appl. No.: 11/284,858

(22) Filed: Nov. 22, 2005

Related U.S. Application Data
(60) Provisional application No. 60/630,948, filed on Nov. 23, 2004.

(51) Int. Cl. G06F 17/20

(52) U.S. Cl. 704/1

(57) ABSTRACT

This invention uses natural language to determine whether words in a document are Objects or Actions. The invention will determine by analyzing both forwards and backwards through a sentence how each Object and each Action in the sentence effects the one another. A energy value is then calculate for each Object and Action. The higher energy value, the more relevant the word is within the document.

### BACKGROUND OF THE INVENTION

1. Field of the Invention

The present invention relates generally to the indexing of content represented in a text document. More particularly the invention relates to pages that are distributed via the Internet or similar mediums and what specific concepts, topics and actions are associated with said documents.

2. Description of Related Art

The classifying and indexing of text documents available via the World Wide Web (“web”) has represented a continual challenge for search engine developers. To provide relevant results to users in response to their search requests, methods have been utilized to clearly define what documents should be returned as valid candidates in response to a particular set of words presented by the search user. However, many commonly used methods examine words as discrete events rather than taking into context what the sentences and documents on the whole are referring to.

### SUMMARY OF THE INVENTION

The purpose of the invention is to enable search engines to better index and classify documents that have been retrieved and which are commonly stored in a repository. It leverages natural language and how words interact and influence one another on a page level as well as on a site level. Each verb (referred to herein as an “action”) and each noun, proper noun, etc (referred to herein as an “object”) has its own inherent usefulness or “energy.” The quantifiable value of this energy is greater or lower depending on how much bearing the word has within the context of the page. The higher the value, the more relevant the word is within the document.

### BRIEF DESCRIPTION OF THE DRAWINGS

The accompanying drawings, incorporated in and constitute part of this specification, illustrate an embodiment of the invention and, together with the description, explain the invention. In the drawings,

FIG. 1 is a diagram illustrating an exemplary system in which concepts consistent with the present invention may be implemented;

FIG. 2A is a flow chart illustrating an exemplary function in which the invention indexes and catalogs words as Objects or Actions;

FIG. 2B a flow chart illustrating an exemplary function in which the invention calculates the Action Frequency of Objects moving forward in a sentence;

FIG. 2C a flow chart illustrating an exemplary function in which the invention calculates the Action Frequency of Objects moving backwards in a sentence;

FIG. 2D a flow chart illustrating an exemplary function in which the invention calculates lexeme Energy of Objects;

FIG. 3A a flow chart illustrating an exemplary function in which the invention calculates the Object Frequency of Actions moving forward in a sentence;

FIG. 3B a flow chart illustrating an exemplary function in which the invention calculates the Object Frequency of Actions moving backwards in a sentence; and

FIG. 3C a flow chart illustrating an exemplary function in which the invention calculates lexeme Energy of Actions.

### DETAILED DESCRIPTION OF THE INVENTION

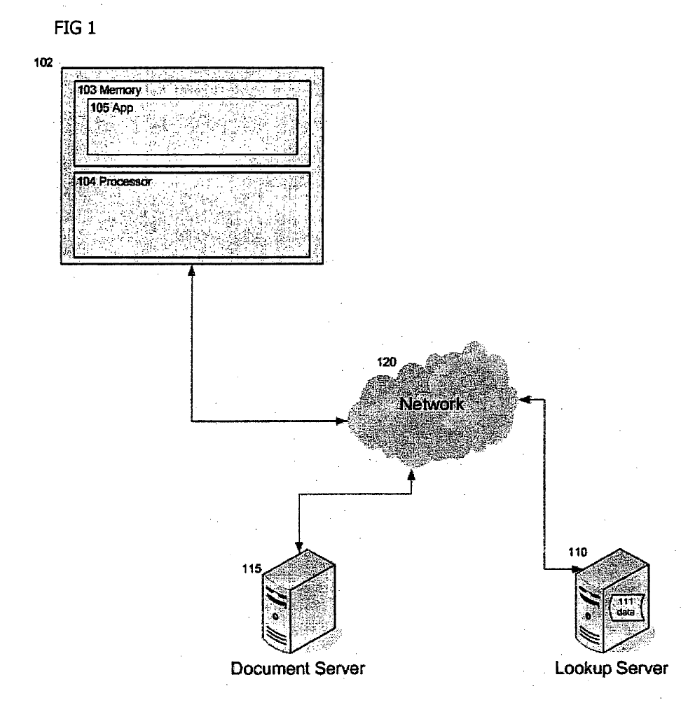

A generalized computer network diagram, consistent with the present invention is illustrated in FIG. 1. The invention consists of an application 105, written in a computer-readable language, executed in memory 103 on any number of computers or servers 102 that are used in conjunction with the indexing and/or classifying process related to text documents and search engines in particular. Computers 102 may be logically connected to a private local area network 120 containing any number of document servers 115 and/or lookup servers 110. FIG. 1 illustrates the invention as being executed in memory 103 in conjunction with the computer 102 running the invention application 105. The computer 102 can, but isn't required to, run invention application 105 locally. In cases where the invention application 105 is not executed locally, it can be accessed over the network 120. Within the lookup servers 110, lookup words, index and energy values are stored 111. These details 111 may be stored in database applications including (but not limited to) MySQL, Oracle, Microsoft SQL Server or Filemaker Pro or as documents formatted as (but not limited to) text, XML or HTML.

The analysis of the document takes into basic consideration that all words work within a finite space with finite degrees of separation. Language is essentially comprised of objects and actions. The present invention derives a meaning of a document by deriving an “energy” of all words within the documents and how the words relate and interact with one another in the finite space of a document.

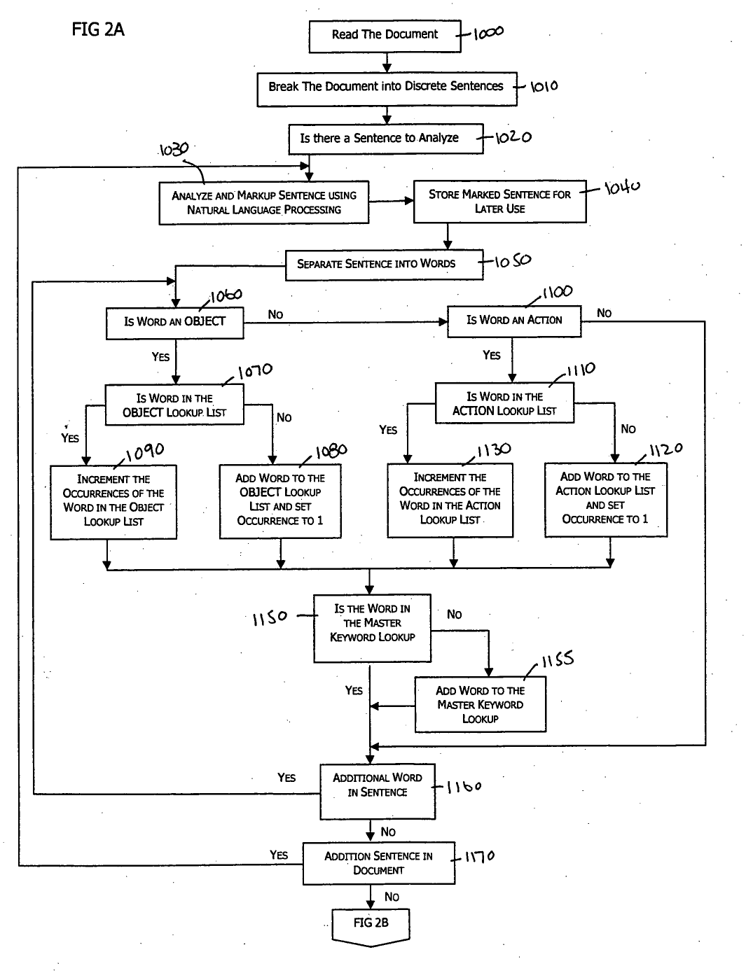

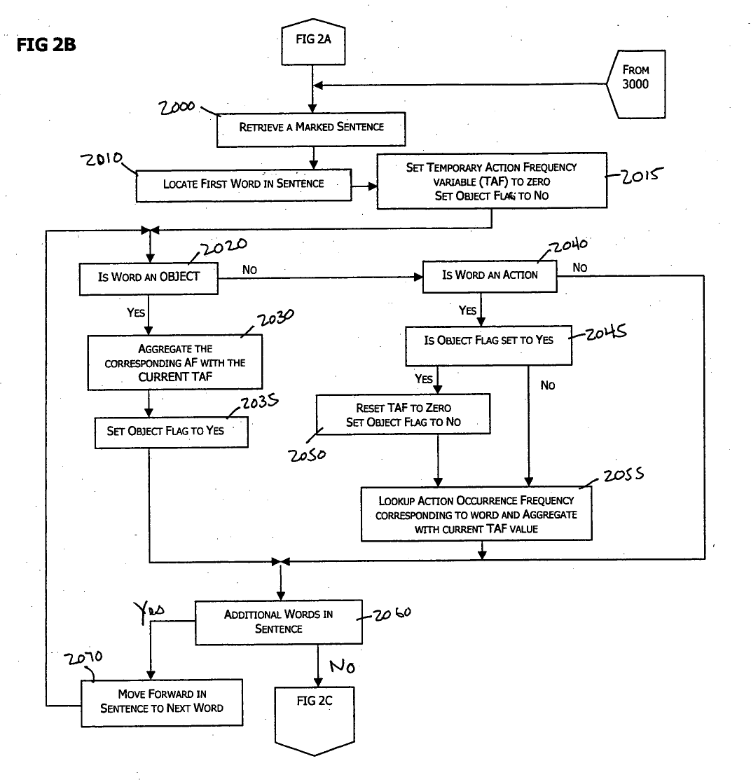

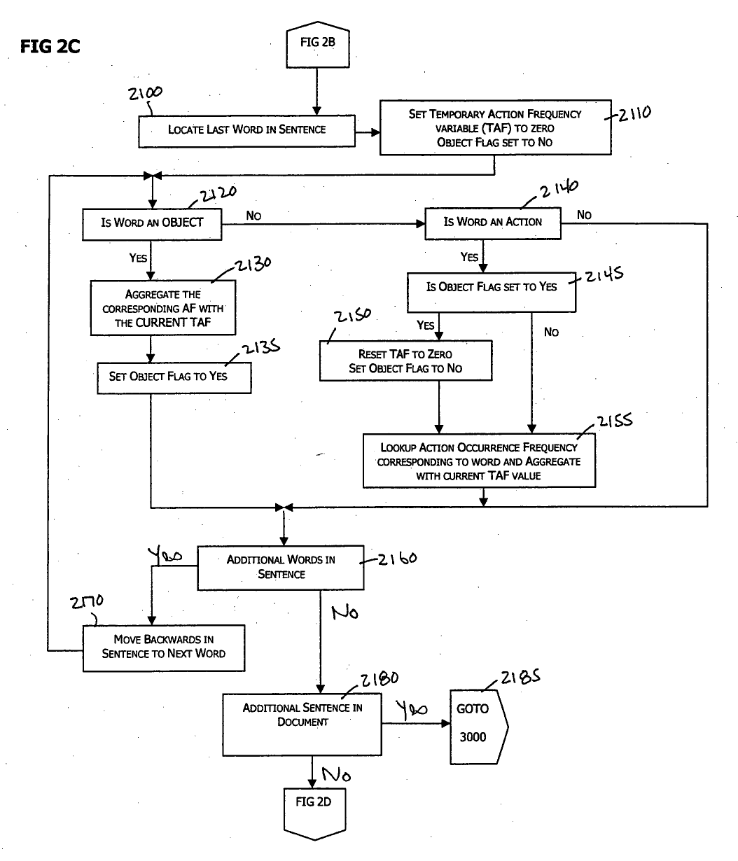

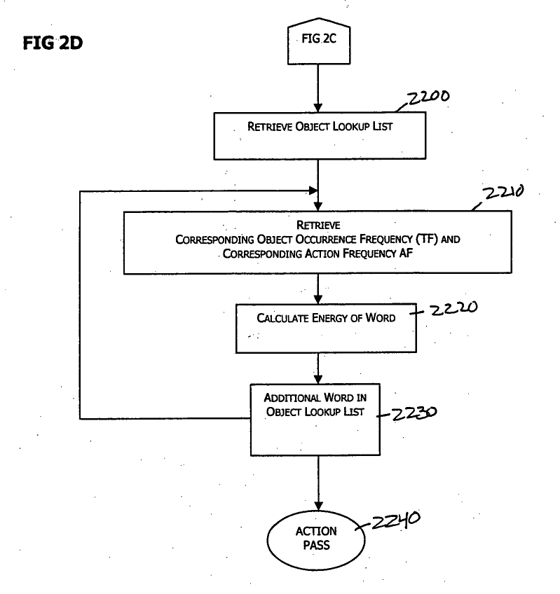

FIG. 2a generally represents an application context in which the invention may be utilized. For each document that is to be indexed, the application reads the document, Step 1000 and then breaks the document into discreet sentences for further processing and analysis, Step 1010. For each sentence, Step 1020, the invention analyzes the content of the sentence using a readily available or customized natural language processing algorithm (NLP), Step 1030, that identifies the parts of speech within the sentence being analyzed and marks up the sentence for further processing. The marked sentence is stored for later use, Step 1040.

In Step 1030, a given sentence can be turned into objects and actions, such that any portion of the sentence would appear as objects interlaced with actions. For example, the sentence:

“The cow jumped and flew over the fence while looking at another cow and the farmer.”

would be marked as the following:

The cow_{object} jumped_{action} and flew_{action} over the fence_{object} while looking_{action} at another cow_{object} and the farmer_{object}.

It has further been determined that, in a given language, objects use actions to act upon other objects in a finite space that is bounded by the beginning of a sentence and the end of the sentence.

Once analyzed, the sentence in broken into discrete words and analyzed further, Step 1050. For each word, the current invention is only concerned with whether the analyzed word is an object or an action. However, the other words may be used to effect the analysis. As previously mentioned objects are common items or things like nouns, proper nouns, etc., while actions are verbs that objects use to act upon another object.

The invention first checks if the word is an Object, Step 1060. If so, the invention searches a list to determine if the Object has already occurred, referred to as an Object Lookup List, Step 1070. If the Object is not in the Object Lookup List, the word is added to the Object Lookup List and an Object Occurrence Frequency corresponding to the word is set to 1, Step 1080. If the Object is already in the Object Lookup List, the Object Occurrence Frequency corresponding to the word is incremented by 1, Step 1090.

If the word is not an Object, then the invention determines whether the word is an Action, Step 1100. If the word is an Action, the invention searches a list of actions to determine if the action has already occurred, referred to as the Action Lookup List, Step 1110. If the Action is not in the Action Lookup List, the word is added to the Action Lookup List and an Action Occurrence Frequency corresponding to the word is set to 1, Step 1120. If the Action is already in the Action Lookup List, the Action Occurrence Frequency corresponding to the word is incremented by 1, Step 1130. Following steps 1090, 1080, 1130 and 1120 the invention then verifies that the word exists within a Master Keyword Lookup List, Step 1150. This list maintains all words for the current document. If the word is in the Master Keyword Lookup List, the invention simply continues to Step 1160. If the word is not in the Master Keyword Lookup List, the word is added, Step 1155.

Following Steps 1150 and 1155 or if the word is neither an Object or Action (Step 1100) the invention then checks if there are additional words in the sentence, Step 1160, and checks if there are additional sentences in the document, Step 1170. Once the invention has completed counting the occurrences of Objects and Actions within the examined document, the invention continues to FIG. 2B.

Using the above exemplary sentence and assuming that no other sentences or documents are being analyzed, the invention would have set the Lookup Lists and corresponding Occurrence Frequencies as:

| | | Action | |
|---|---|---|---|
| Object Lookup | Corresponding Object | Lookup | Corresponding Action |
| List | Occurrence Frequency | List | Occurrence Frequency |
| Cow | 2 | jumped | 1 |
| fence | 1 | flew | 1 |
| farmer | 1 | looking | 1 |

It is also important to note that the words may be broken into their root words such that Actions such as jumped, jumping and jumps are grouped and viewed as a single Action with multiple occurrences; similarly, objects such as cow and cows can be grouped together as a single Object with multiple occurrences.

While the invention is shown to continue to FIG. 2B, it should be readily apparent that the order of the following analysis can be changed without effecting the outcome of the present invention. Moreover, while shown and explained as separate functions, the following may be done together or simultaneously on different servers with a central server providing access to the results for final analysis.

Referring now to FIG. 2B, in this stage, the invention begins to calculate the “energy” annotations for each of the words being used in the sentences within the document. This stage may be referred to as the Object Pass, as the invention will analyze and calculate the energy for the Objects used in the documents. The Action Pass is discussed after the Object Pass, however as just mentioned, the order or arrangement may be changed without effecting the scope of the invention.

First, a marked sentence is retrieved, Step 2000. In the example used herein, the marked sentence is The cow_{object} jumped_{action} and flew_{action} over the fence_{object} while looking_{action} at another cow_{object} and the farmer_{object}. The sentence is checked moving both forwards through each word of the sentence and then backwards through the sentence. The order, whether checking first forwards or first backwards is not important as long as both are checked. Moreover, less accurate energy scores could be obtained by only checking forwards or only checking backwards; this alternate less accurate embodiment is contemplated by the present invention.

In Step 2010, the first word in the sentence is identified, a Temporary Action Frequency variable (TAF) is established and is set to zero and an Object Flag is set to No, Step 2015. As will become readily apparent in the discussion relating to the Action Pass, it is important to default the Object Flag in case the sentence begins with an Action. Next, the invention checks if the word is an Object, Step 2020. If the word is an Object, the Object's corresponding Action Frequency value (hereinafter AF) is aggregated with the current value of the Temporary Action Frequency variable, Step 2030. Initially all words have an Action Frequency value equal to zero. The Object Flag is set to Yes, Step 2035. If the word is not an Object, the invention checks if the word is an Action, Step 2040. If the word is an Action, the invention checks to see of the Object Flag is set to Yes, Step 2045. If the Object Flag is set to Yes, then the invention knows that the previous word was an Object, as such the invention will reset the TAF to zero and set the Object Flag to No, Step 2050. From Step 2050 or if the Object Flag was set to No (Step 2045), the invention proceeds to Step 2055, where the current value of the Temporary Action Frequency variable is aggregated with the word's Corresponding Action Occurrence Frequency value recorded previously. Following Steps 2055, 2035, or if the word is not an Object or Action (Step 2040), the invention then determines if there are other words in the sentence, Step 2060 and if so the invention moves forward in the sentence to the next word, Step 2070, and returns to Step 2020. Once the forward review in the Object Pass is completed, the invention checks the reverse or backwards review in the same sentence. At the end of the forward review in the Object Pass for the exemplary sentence, the TAF values for the objects would follow the below logic.

The TAF is initially set to zero. The first word COW is retrieved. The word is an object (Step 2020) which causes the invention to aggregate the word's AF with the current TAF value or zero to the word COW (Step 2030). Since initially all words have an AF of zero the aggregate value of AF is still zero. An Object Flag is set to yes (Step 2035), which indicates that the last word analyzed was an object. The next word JUMPED is retrieved. The word JUMPED is an action (Step 2040) and the Object Flag is set to Yes (Step 2045). The TAF is reset to zero and the Object Flag is set to No (Step 2050). The invention then retrieves the Action Occurrence Frequency (AOF) corresponding to the word JUMPED and aggregates the value to the current value of TAF (Step 2055). The AOF value is 1 and the current value of TAF is zero, providing an aggregate value of 1 which is now the current value of TAF. The next word FLEW is an action (Step 2040). Since the Object Flag is No (Step 2045), the AOF for the word is retrieved (a value of 1) and aggregated to the current value of TAF (which is 1). The now current value of TAF to 2 (Step 2055). The next word FENCE is an object (Step 2020). The current value of TAF, a value of 2, is aggregated to the AF (a value of zero) of the word FENCE (Step 2030). The new AF for the word FENCE is 2. The Object Flag is set to Yes (Step 2035). The next word LOOKING is an action (Step 2040). Since the Object Flag is set to Yes (2045), the TAF is reset to zero and the Object Flag is set to No (Step 2050). The AOF value of the word LOOKING (value of 1) is retrieved and aggregated to the current value of TAF, a value of zero, (Step 2055). The next word COW is an object. The AF value of the word is still zero but is now assigned the current TAF value of 1. The Object Flag is also set to Yes (Step 2035). The last word FARMER, which also has an initial AF value of zero is also assigned the current TAF value of 1, since there were no actions between the two objects, the TAF value is not reset. Thus after the forward review of the sentence the AF values are as follows:

| Object | AF value in Forward Review |
|---|---|
| Cow | 1 |
| FENCE | 2 |
| FARMER | 1 |

The invention now analyzes the Objects going backwards through the sentence, FIG. 2C. First, the last word in the sentence is located, Step 2100. The TAF is set to zero and the Object Flag is defaulted to No, Step 2110. The word is analyzed to see if it is an Object, Step 2120. If it is an Object, the AF of the word is aggregated with the current value of TAF, Step 2130 and the Object Flag is set to Yes, Step 2135. If the word is not an Object, the invention checks if the word is an Action, Step 2140. If the word is an Action, the invention checks to see of the Object Flag is set to Yes, Step 2145. If the Object Flag is set to Yes, then the invention knows that the previous word was an Object, as such the invention will reset the TAF to zero and set the Object Flag to No, Step 2150. From Step 2150 or if the Object Flag was set to No (Step 2145), the invention proceeds to Step 2155, where the current value of the Temporary Action Frequency variable is aggregated with the word's Corresponding Action Occurrence Frequency value recorded previously. Following Steps 2155, 2135, or if the word is not an Object or Action (Step 2140), the invention then determines if there are other words in the sentence, Step 2160 and if so the invention moves backwards in the sentence to the next word, Step 2170, and returns to Step 2120. Once the backward review in the Object Pass is completed, checks whether additional sentences in the document need to be analyzed, Step 2180. If so the invention moves to step 3000 for further sentence analyzing, Step 2185. Otherwise, the invention proceeds to FIG. 2D. At the end of the backward review in the Object Pass for the exemplary sentence, the TAF values for the objects would follow the below logic.

The TAF is initially set to zero. The last word FARMER is retrieved. The word is an object (Step 2120) with an AF value of 1. Since the current TAF value is zero, the AF value of 1 remains unchanged (Step 2130). An Object Flag is set to yes (Step 2135), which indicates that the last word analyzed was an object. The next word COW is retrieved. The word is an Object (Step 2120) which causes the TAF value of zero to be aggregated with the current AF, a value of 1. The next word LOOKING is an action (Step 2140). Since the Object Flag is set to Yes (Step 2145) the TAF value is reset to zero and the Object Flag is set to No (Step 2150). The invention then retrieves the AOF corresponding to the word LOOKING and aggregates the value to the current value of TAF (Step 2155). The AOF value is 1 and the current value of TAF is zero, providing an aggregate value of 1 which is now the current value of TAF. The next word FENCE is an Object (Step 2120). The AF value of FENCE is 2 which is aggregated with the current TAF value of 1, providing a new AF value of 3, which is assigned to the word FENCE. The Object Flag is also set to Yes (Step 2135). The next word FLEW is an Action. Since the Object Flag is set to Yes, the TAF value is reset to zero and the Object Flag is set to No (Step 2150). The AOF value of FLEW is 1, as such the TAF value is set to 1 (Step 2155). The next word is JUMPED, also an Action. The Object Flag is set to No, thus the TAF value of 1 is aggregated with the AOF value of the word JUMPED. The new current TAF value is 2. The next word is COW. The AF value of COW is 1 which is aggregated with the TAF value of 2, providing a new AF value of 3. Thus after the backward review of the sentence the AF values are as follows:

| Object | AF value after Backward Review |
|---|---|
| COW | 3 |
| FENCE | 3 |
| FARMER | 1 |

The aggregate values of AF could also be calculated after the forward and backward reviews, in a separate algorithm. Also the AF values may be stored in the Object Lookup List:

| Object | Corresponding Object | |
|---|---|---|
| Lookup List | Occurrence Frequency | AF Value |
| Cow | 2 | 3 |
| fence | 1 | 3 |
| farmer | 1 | 1 |

Once the AF values for the Objects have been determined, a Lexical Energy for each Object can be calculated. Referring now to FIG. 2D, in accordance with the present invention, the Object Lookup List is retrieved, Step 2200. For each Object or word in the Object Lookup List, the Corresponding Object Occurrence Frequency value (TF) and the Corresponding Action Frequency (AF) (retrieved in Step 2210) is used to calculate the energy of the word in the documents. The energy is calculated in Step 2220, in accordance with the present invention. The energy has been found to be:
E_{word}=(log(TF_{word}*10)+AF_{word})*100,000

where
E_{word} is the energy of the word
TF_{word} is the Corresponding Object Occurrence Frequency value;
AF_{word} is the Corresponding Action Frequency; and
the values of 10 and 100,000 are used as normalizing multiplies, these values can be changed or omitted without effecting the scope of the invention.

If additional words exist in the Object Lookup List, Step 2230, the invention returns to step 2210. If the energy has been calculated for each word the invention has completed the Object Pass and will continue with the Action Pass, Step 2240. The energy value for each word may be stored in the Object Lookup List:

| Object | Corresponding Object | AF | |
|---|---|---|---|
| Lookup List | Occurrence Frequency | Value | Energy |
| Cow | 2 | 3 | 430102 |
| fence | 1 | 3 | 430102 |
| farmer | 1 | 1 | 200000 |

Once the invention has completed the Object Pass, it moves on to repeat the process in the Action Pass for each sentence of the document. The Action Pass determines how the Objects effect the Actions in the document.

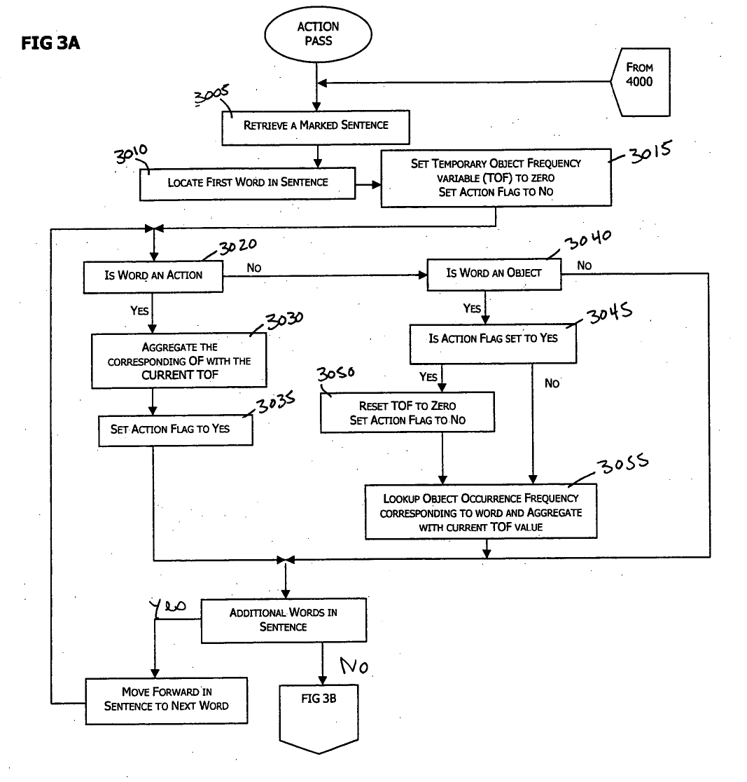

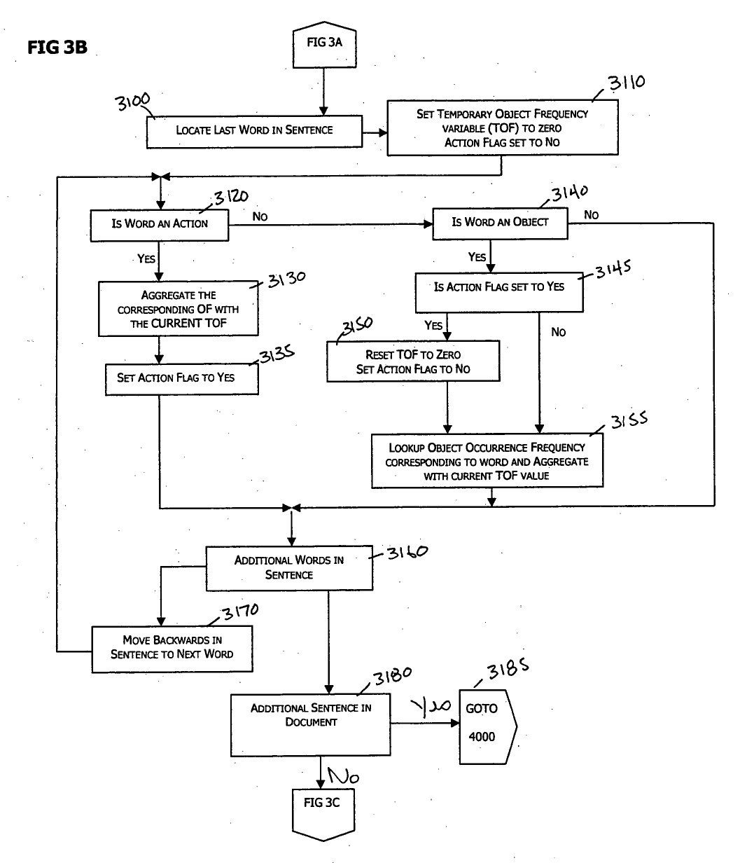

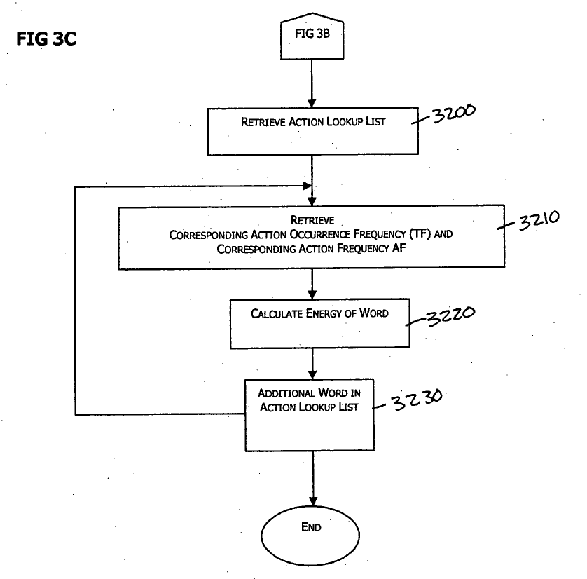

Referring now to FIG. 3a, a marked is sentence is first retrieved, Step 3005. Next in Step 3010, the first word in the sentence is identified, a Temporary Object Frequency variable (TOF) is set to zero and an Action Flag is set to No, Step 3015. Next, the invention checks if the word is an Action, Step 3020. If the word is an Action, the Action's corresponding Object Frequency value (hereinafter OF) is aggregated to the current value of the Temporary Object Frequency (TOF) variable, Step 3030. Initially all Actions have a zero Object Frequency value. The Action Flag is set to Yes, Step 3035. If the word is not an Action, the invention checks if the word is an Object, Step 3040. If the word is an Object, the invention checks to see of the Action Flag is set to Yes, Step 3045. If the Action Flag is set to Yes, then the invention knows that the previous word was an Action, as such the invention will reset the TOF to zero and set the Action Flag to No, Step 3050. From Step 3050 or if the Action Flag was set to No (Step 3045), the invention proceeds to Step 3055, where the current value of the Temporary Object Frequency variable is aggregated with the word's Corresponding Object Occurrence Frequency (OOF) value recorded previously. Following Steps 3055, 3035, or if the word is not an Action or Object (Step 3040), the invention then determines if there are other words in the sentence, Step 3060 and if so the invention moves forward in the sentence to the next word, Step 3070, and returns to Step 3020. Once the forward review in the Action Pass is completed, the invention checks the reverse or backwards review in the same sentence. At the end of the forward review in the Action Pass for the exemplary sentence, the TOF values for the objects would follow the below logic.

The TOF is initially set to zero and the Action Flag is set to No (Step 3015). The first word COW is retrieved. The word is an object (Step 3040) and the Action Flag is set to No (Step 3045) causing the Invention to move to Step 3055. The OOF of the word COW is retrieved (a value of 2) and aggregated to the current value of TOF (a value of zero) (Step 3055). The new current TOF value is thus 2. The next word JUMPED is retrieved. The word JUMPED is an action (Step 3020). Initially all Actions have an Object Frequency or OF of zero. Since this is the first occurrence of JUMPED the OF (value of zero) is aggregated with the current TOF (value of 2). The OF of the word JUMPED is 2. The Action Flag is now set to Yes. The next word FLEW is an action (Step 3020). The OF value of FLEW (zero) is aggregated with the current value of TOF (2) providing a new OF value for FLEW of 2. The next word FENCE is an object (Step 3040). The Action Flag is set to Yes (Step 3045) causing the Invention to reset the TOF to zero and resetting the Action Flag to No (Step 3050). The OOF of the word FENCE (a value of 1 is retrieved) and is aggregated with the current TOF value (zero) (Step 3055). The new current TOF value is 1. The next word LOOKING is an Action (Step 3020). The OF value of LOOKING is zero which is aggregated with the current TOF value. The new OF value assigned to LOOKING is 1 (Step 3030). The Action Flag is set to Yes (Step 3035). The next word COW is an object (Step 3040). Since the Action Flag is set to Yes (Step 3045) the TOF to reset to zero and the Action Flag to reset to No (Step 3050). The OOF of the word COW is retrieved (a value of 2) which is aggregated to the current TOF value for a new. TOF value of 2. The last word FARMER is an Object and since the Action Flag is set to No (step 3045), the current value of TOF (a value of 2) is aggregated with the OOF value of the word FARMER (a value of 1) to give a new current value of 3. Thus after the forward review of the sentence the OF values are as follows:

| Action | OF value in Forward Review |
|---|---|
| JUMPED | 2 |
| FLEW | 2 |
| LOOKING | 1 |

The invention now analyzes the Actions going backwards through the sentence, FIG. 3B. First, the last word in the sentence is located, Step 3100. The TOF is set to zero and the Action Flag is defaulted to No, Step 3110. The word is analyzed to see if it is an Action, Step 3120. If it is an Action, the OF of the word is aggregated with the current value of TOF, Step 3130 and the Action Flag is set to Yes, Step 3135. If the word is not an Action, the invention checks if the word is an Object, Step 3140. If the word is an Object, the invention checks to see of the Action Flag is set to Yes, Step 3145. If the Action Flag is set to Yes, then the invention knows that the previous word was an Action, as such the invention will reset the TOF to zero and set the Action Flag to No, Step 3150. From Step 3150 or if the Action Flag was set to No (Step 3145), the invention proceeds to Step 3155, where the current value of the Temporary Object Frequency variable is aggregated with the word's Corresponding Object Occurrence Frequency value recorded previously. Following Steps 3155, 3135, or if the word is not an Action or Object (Step 3140), the invention then determines if there are other words in the sentence, Step 3160 and if so the invention moves backwards in the sentence to the next word, Step 3170, and returns to Step 3120. Once the backward review in the Object Pass is completed, the invention checks whether additional sentences in the document need to be analyzed, Step 3180. If so the invention moves to step 4000 for further sentence analyzing, Step 3185. Otherwise, the invention proceeds to FIG. 3C. At the end of the backward review in the Action Pass for the exemplary sentence, the TOF values for the objects would follow the below logic.

The TOF is initially set to zero and Action Flag is set to No. The last word FARMER is retrieved. The word is an Object (Step 3140) with an OOF value of 1. Since the current TOF value is zero, the new TOF value is 1 (Step 3155). The next word COW is retrieved. The word COW is an Object (Step 3140) and the Action Flag is still set to No (Step 3145). The OOF value of COW is 2 which is aggregated with the TOF value of 1, assigned the new current TOF value of 3. The next word LOOKING is an Action (Step 3120). The OF value of LOOKING is 1 which is aggregated to the current TOF value of 3, assigning a new OF value of 4 (Step 3135). The Action Flag is set to Yes (step 3135). The next word FENCE is an Object (Step 3140). Since the Action Flag is set to Yes (Step 3145), the TOF value is reset to Zero and the Action Flag is set to No (Step 3150). The OOF value of the word FENCE is retrieved (a value of 1) which is aggregated with the TOF value for a new current TOF (value 1) (Step 3155). The next word FLEW is an Action (Step 3120). THE OF value of FLEW is 2, which is aggregated with the TOF value of 1, for a new OF value of 3 (Step 3130). The Action Flag is set to Yes (Step 3135). The next word is JUMPED, also an Action (Step 3120). The current OF value of JUMPED is 2 which is aggregated with the current TOF value of 1 for a new OF value of 3 (Step 3130). The next word is COW which is an Object (Step 3140). The Action flag is set to Yes (Step 3145) causing the TOF value to reset to zero and the Action Flag to reset to No (Step 3150). The OOF value of the word COW (a value of 2) is aggregated with the TOF value for a new current TOF value of 2 (Step 3155). Since there are no more additional words in the sentence (Step 3160) and no more sentences in the document (Step 3180), the invention may proceed to calculate the Energy values. After the backward review of the sentence the AF values are as follows:

| Action | OF value after Backward Review |
|---|---|
| JUMPED | 3 |
| FLEW | 3 |
| LOOKING | 4 |

The aggregate values of OF could also be calculated after the forward and backward reviews, in a separate algorithm. Also the OF values may be stored in the Action Lookup List:

| Action | Corresponding Object | |
|---|---|---|
| Lookup List | Occurrence Frequency | OF Value |
| JUMPED | 1 | 3 |
| FLEW | 1 | 3 |
| LOOKING | 1 | 4 |

Once the OF values for the Actions have been determined, a Lexical Energy for each Action can be calculated. Referring now to FIG. 3C, in accordance with the present invention, the Action Lookup List is retrieved, Step 3200. For each Action or word in the Action Lookup List, the Corresponding Action Occurrence Frequency value (TF) and the Corresponding Object Frequency (OF) (retrieved in Step 3210) is used to calculate the energy of the word in the documents. The energy is calculated in Step 3220, in accordance with the present invention. The energy has been found to be:
E_{word}=(log(TF_{word}*10)+OF_{word})*100,000

where
E_{word} is the energy of the word
TF_{word} is the Corresponding Action Occurrence Frequency value;
AF_{word} is the Corresponding Object Frequency; and
the values of 10 and 100,000 are used as normalizing multiplies, these values can be changed or omitted without effecting the scope of the invention.

If additional words exist in the Action Lookup List, Step 3230, the invention returns to step 3210. If the energy has been calculated for each word the invention has completed the Action Pass. The energy value for each word may be stored in the Action Lookup List:

| Action | Corresponding Object | OF | |
|---|---|---|---|
| Lookup List | Occurrence Frequency | Value | Energy |
| JUMPED | 1 | 3 | 430102 |
| FLEW | 1 | 3 | 430102 |
| LOOKING | 1 | 4 | 560205 |

As such in the above example, the word LOOKING had the highest energy and the word FARMER had the lowest energy. Upon further examination of the sentence: “The cow_{object} jumped_{action} and flew_{action} over the fence_{object} while looking_{action} at another cow_{object} and the farmer_{object}.” The word FARMER had the least effect on the overall sentence. The only action the FARMER saw was when the COW looked at him. While the Action LOOKING had the most effect. Because the COW looked at two objects. While the COW only JUMPED over one Object and flew over one Object.

The calculation of energy and the utilization of the log of the TF becomes more apparent when there are numerous sentences across numerous pages.

During a search engine query, a user's query terms can be matched to words in multiple documents. The documents can be weighted and sorted based upon the energy of the matched words in the documents. If multiple words are used in the query string, the energy of each word can be aggregated to compile an aggregate energy for each matching document. The user would then be provided with a list of documents sorted in ascending order, the document highest energy appearing first.

In such a query the method to sort the documents based upon a search query may be conducted in accordance to the following. First, the documents may be initially sorted and reviewed to compile a set of documents that contains terms related, similar or identical to the terms in a query string. The set of documents are then reviewed and the energy of the query string is calculated. Rather than calculating the energy of each action and object in the document, it is possible to only calculate the energy of the relevant query string. In such circumstances, the occurrence frequency of each word in the query string is calculated. Each sentence in the document which contains the query string is reviewed. The words in the identified sentences are identified as objects and actions. And an aggregate frequency of the words in the query string is found based upon the influence of the actions and objects upon the words in the query string. The aggregate frequency is found as described above and may include both forward and backward passes or just one of the passes. The energy of the words in the query string can then be calculated, also in accordance to the above. Lastly, the set of documents can be sorted based upon the energy of the query string. The sorted documents would be displayed as links to the user, with the more relevant documents appearing first.

From the foregoing and as mentioned above, it will be observed that numerous variations and modifications may be effected without departing from the spirit and scope of the novel concept of the invention. It is to be understood that no limitation with respect to the specific embodiments illustrated herein is intended or should be inferred.

I claim:

1. A method of sorting documents based on a search query containing at least one word, comprising:
obtaining a set of documents of said documents, wherein each document in said subset of documents contains said at least one word in said search query;
for each document in said set of documents, calculating an energy of said at least one word, of said search query, wherein said energy of said at least one word is determined by the following:
calculating an occurrence frequency of said at least one word in said document;
identifying a sentence in said document that contains said at least one word, of said search query;
identifying in said sentence addition words as actions and objects;
determining an aggregate frequency of said at least one word, of said search query, based upon an influence of said actions and objects upon said at least one word; and
calculating an energy of said at least one word, of said search query, where said energy is based upon said occurrence frequency and said aggregate frequency; and
sorting said set of documents based upon the energy of said at least one word, wherein said sorted set of documents are provided in response to said search query.

2. The method of sorting documents of claim 1, wherein the step of obtaining a set of documents includes identifying each document in said documents that contains said at least one word in said search query.

3. The method of sorting documents of claim 1, wherein the step of determining an aggregate frequency includes parsing the sentence in forward and backward passes to calculate a forward frequency and a backward frequency wherein said aggregate frequency is based upon said forward frequency and said backward frequency.

4. The method of sorting documents of claim 1, wherein said search query contains at least two words, includes the steps of calculating the energy of each word in said search query and aggregating said energy of each word to define an aggregate energy such that said sorting step is based upon said aggregate energy of said search query.

5. A method of sorting documents based on a search query containing at least one word, comprising:
obtaining a set of documents;
assigning document energy scores to the documents based on an energy of words matching said search query within each document, of said set of documents; and
sorting the documents based on the assigned document energy scores.

6. The method of claim 5, wherein the step of assigning document energy scores includes the following:
identifying all documents, of said set of documents, that contain words matching said search query;
analyzing sentences, in all identified documents, that contain said matching words by determining an energy score of said matching words where said energy is based upon an influence of additional words, in said sentences, that act upon said matching words; and
determining the document energy scores as being an aggregate of said energy score of each matching word, or said matching words, in a single document.

7. The method of claim 6, wherein the step of analyzing sentences further includes, for each sentence:
identifying additional words in said sentence as objects and actions; and
determining the energy score of said matching words based upon the influence of all objects and actions in said sentence.

8. A method for ranking words in a document containing at least one sentence, the method comprising:
identifying words in said sentence as being an object or action;
calculating an occurrence frequency of each object and action;
calculating an action frequency for each object and computing an object frequency for each action;
calculating an energy for each object based upon said occurrence frequency of each object and said action frequency corresponding to said object;
calculating an energy for each action based upon said occurrence frequency of each action and said object frequency corresponding to said action;
weighting said energy for each object and action in ascending order to identify the words meaning in said document.

9. The method of claim 8, wherein the step of calculating an action frequency for each object is further defined as:
parsing the sentence in a forward pass and determining a forward action frequency for each object through said forward pass;
parsing the sentence in a backward pass and determining a backward action frequency for each object through said backward pass; and
aggregating said forward action frequency and said backward action frequency to calculate said action frequency for each object.

10. The method of claim 8, wherein the step of computing an object frequency for each action is further defined as:
parsing the sentence in a forward pass and determining a forward object frequency for each action through said forward pass;
parsing the sentence in a backward pass and determining a backward object frequency for each action through said backward pass; and
aggregating said forward object frequency and said backward object frequency to calculate said object frequency for each action.
